(19) United States
(12) Patent Application Publication
(10) Pub. No.: US 2018/0096073 A1
(43) Pub. Date: Apr. 5, 2018

(54) Recommendations Based On User Preference And Activities

(71) Applicant: Aiooki Limited, Grand Cayman (KY)

(72) Inventors: Lam Sun, Foster City, CA (US); Boxiong Ding, San Jose, CA (US); Kuan-Cheng Lai, Santa Clara, CA (US)

(21) Appl. No.: 15/472,237

(22) Filed: Mar. 28, 2017

Related U.S. Application Data
(60) Provisional application No. 62/404,714, filed on Oct. 5, 2016.

(51) Int. Cl. G06F 17/30

(52) U.S. Cl. CPC G06F 17/30867; G06Q 30/0631

(57) ABSTRACT

Some embodiments can provide a recommender system configured to recommend a new item to a user by estimating a user interest for the item. The recommendation system may be configured to collect data regarding user activities with respect to various existing items. Based on the user activity data, the user interest for the new item may be estimated and a determination may be made whether the new item is to be recommended to the user based on the estimated interest. In one embodiment, the new item's attribute vector is compared with a user vector to estimate the user's interest to the new item. In another embodiment, a score indicating the user's interest may be iteratively estimated through matrix factorization based on the user activity data.

### CROSS-REFERENCE TO RELATED APPLICATIONS

The present application claims priority to U.S. Provisional Patent Application No. 62/404,714, filed on Oct. 5, 2016 and entitled “ENHANCED USER MATCHING, RECOMMENDATION AND PREDICATION SYSTEMS”, the disclosures of which is hereby incorporated by reference in their entireties for all purposes.

### BACKGROUND OF THE INVENTION

The disclosure relates to user matching and generating recommendation for users using a computer system.

User matching is generally known in the art. Existing user matching technologies typically match users based on their preferences or certain user characteristics. For example, two users may be matched simply based on their geographical locations. Under the existing user matching technologies, the user matching may be refined until an acceptable result is obtained. For example, the conventional matching technologies may first start with a big group of users that can be matched based on their generally geographical regions (e.g., their current countries), and fine-tuned to match their finer locations as desired (e.g., their current cities).

Recommendation systems are generally known in the art. Existing recommendation systems typically recommend an entity (e.g., a website) to a user based on a relationship between the recommended entity and the user's interest. For example, some of the existing recommendation systems are configured to collect data regarding user browsing activities and analyze such data to learn the user's interest. These systems are also configured to determine a likelihood the user will visit the website based on the learned user interest and select a website for recommendation to the user based on the determined likelihood the user will visit the website.

Bidding systems are generally in the art. Existing bidding systems are typically configured to receive user bids for a certain item. A given user bid that is received by the existing bidding systems typically a user determined price and an identification of the given item. The existing bidding systems are typically configured to compare all received user bids to determine a winning bid.

### BRIEF SUMMARY OF THE INVENTION

Some embodiments can provide a recommender system configured to recommend a new item to a user by estimating a user interest for the item. The recommendation system may be configured to collect data regarding user activities with respect to various existing items. Based on the user activity data, the user interest for the new item may be estimated and a determination may be made whether the new item is to be recommended to the user based on the estimated interest. In one embodiment, a content based filtering algorithm is employed. In that embodiment, the new item's attribute vector is compared with a user vector to estimate the user's interest to the new item. In some implementations, the user vector is constructed based on the user activity data. In another embodiment, a collaborative-based filtering approach is employed. In that embodiment, a score indicating the user's interest may be iteratively estimated through matrix factorization based on the user activity data. In one embodiment, the recommender system is configured to recommend an investment product to the user.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

FIG. 1 illustrates an example of user viewing matrix that can be constructed from user activity data.

FIG. 2 illustrates user interest level about an item can be estimated by factorizing the matrix shown in FIG. 1 into two intermediate matrixes.

FIG. 3 illustrates an estimated user viewing matrix in accordance with the disclosure can have different values when comparing to the user viewing matrix shown in FIG. 1.

FIG. 4 illustrates an example of user vectors that can be built when the items include real-estate properties.

FIG. 5 illustrates an example where vectors shown in can be plotted in a graph and a determination of recommendation for an item can be made to the users based on cosine similarities between the vector for that item and the user vectors.

FIG. 6 illustrates an example of a user matching system in accordance with the disclosure.

FIG. 7 illustrates an exemplary method for recommending one or more items to a given user in accordance with the disclosure.

FIG. 8 illustrates an exemplary method for recommending one or more investment to a given user in accordance with the disclosure.

FIG. 9 is a block diagram of computer system that can be used to implement various embodiments described and illustrated herein.

### DETAILED DESCRIPTION OF THE INVENTION

Some embodiments can provide a recommender system configured to determine whether to recommend an item to a given user. The item may include a web page, a product, a news story, a particular web content, an investment property, and/or any other type of items. For example, in one embodiment, the recommender system in accordance with the disclosure is configured to determine whether to recommend to a given user an investment property such as a real-estate property, a stock, a particular commodity, and/or any other investment properties. For achieving this, the recommender system in accordance with the disclosure can be configured with various filtering techniques such as collaborative filtering and content filtering. In some embodiments, the recommender system in accordance with the disclosure can be configured to capture activity data for a give user and determine the given user's interests toward one or more items based on the captured activity data. The recommender system can be configured to estimate the given user's interest towards another item based on the given user interest in those items.

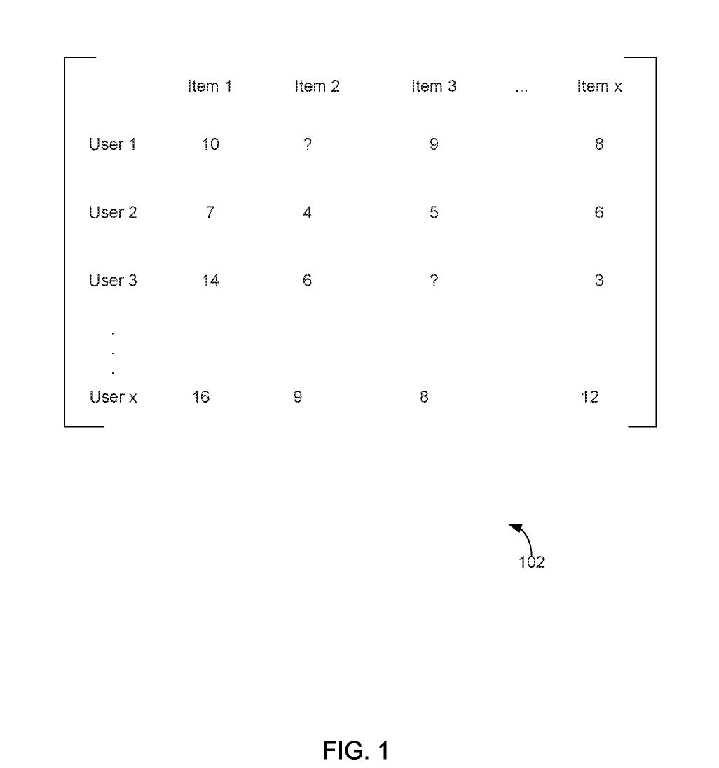

Under a collaborative filtering approach, the captured user activity data can be used to construct a user viewing matrix to indicate user viewing of various items. FIG. 1 illustrates an example of user viewing matrix 102 that can be constructed from user activity data. As shown, the user viewing matrix 102 in this example captures a number of times a given user has viewed the items. For instance, user 2 has viewed item 1 7 times, item 2 4 times, item 3 5 times, and item x 6 times. Such viewing times can be obtained and populated into the user viewing matrix 102 for individual users from the user activity data obtained from user applications, e.g., browsers or apps, or from user activity monitoring programs. As also shown, viewing times for some items by certain users may be unknown due to missing user activity data for those. It is these items the recommender system determines whether to recommend the to those certain users. For instance, as shown in FIG. 1, the number of times of item 2 viewed by user 1 is unknown in this example. This may be due to user 1 is unaware of item 2; or item 2 is new to user 1 and user 1 has not had a chance viewing item 2. Likewise, the number of times item 3 viewed by user 3 is also unknown for similar reasons. The goal is to estimate a level of interest user 1 may have toward item 2 if the user was aware of item 2 or had the chance viewing item 2 already; and a level of interest user 3 may have toward item 3.

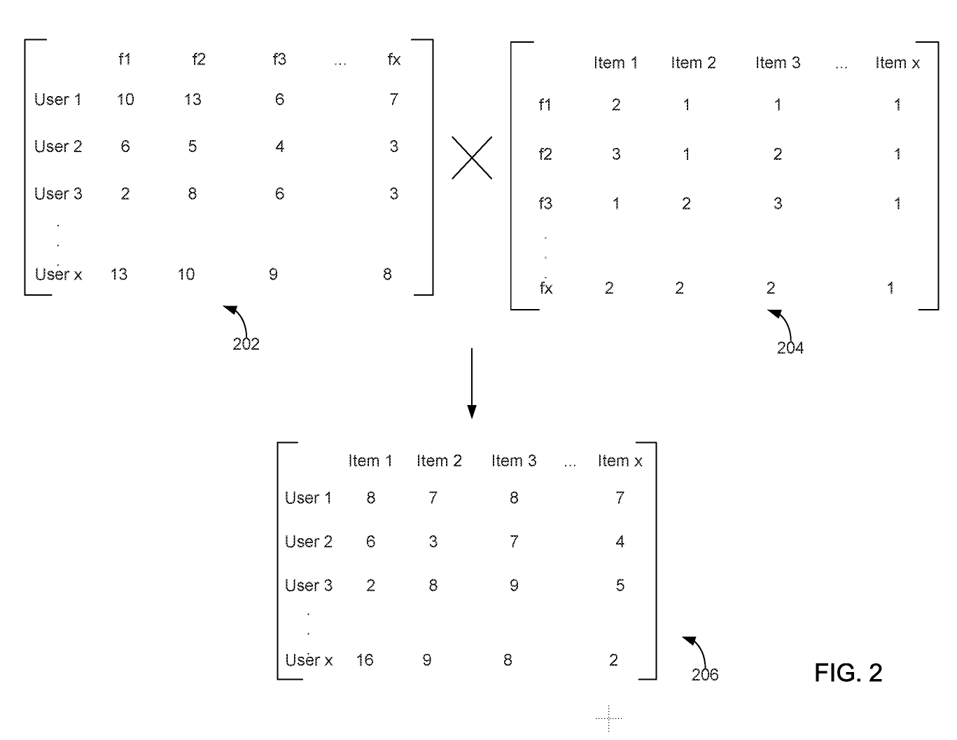

As shown in FIG. 2, the estimation can be first carried out by factorizing matrix 102 into two intermediate matrixes. The first intermediate matrix is 202 which can be constructed using a set of latent features about the items in matrix 102. The number of latent features can be pre-defined at a configuration stage of the recommender system in accordance with the disclosure. For example, 20 latent features can be predefined. The latent features can include features that are specific to the items. For instance, when the items include real-estate properties, the latent features can include number of bedrooms, bath rooms, living rooms, the house remodeling features, lot size, year built, and/or any other specific feature about the real-estate properties. However, this is not necessarily the only case. In some embodiments, the latent features can include abstract features that can be extracted from the items under the collaborative filtering approach. One skilled in the art will understand how to extract those abstract features from the items. In any case, the predefined latent features can be extracted from the items to construct intermediate matrix 202 indicating a number of times the individual users have viewed those features based on the viewing times indicated in matrix 1102.

Also shown in FIG. 2 is matrix 204, which indicates the predefined latent features in relation to the items shown in matrix 102. For example, when the items are real-estate properties, f1 may be the number of bed rooms, f2 may be the number of living rooms, f3 may be the number of bathrooms, and fx may be the number of floors. The number of these features in each item can be populated into matrix 204 based on background information about those items. For instance, item 1 has two f1, three f2, one f3 and two f4.

Still shown in FIG. 2 is that matrixes 202 and 204 can be multiplied to obtain an estimated viewing matrix 206. As shown, the estimated viewing matrix 206 can have estimated viewing times by the individual users for different items. As shown, the estimated view matrix 206 has a value, 7 for item 2 as viewed by user 1, which is missing in matrix 102; and also has a value 9, for item 3 as viewed by user 3, which is also missing matrix 102. These values are of course estimated values based on known values—i.e., estimated from user 1 viewing of other items that have features in common with item 2, and from user 3 viewing of other items that have features in common with item 3.

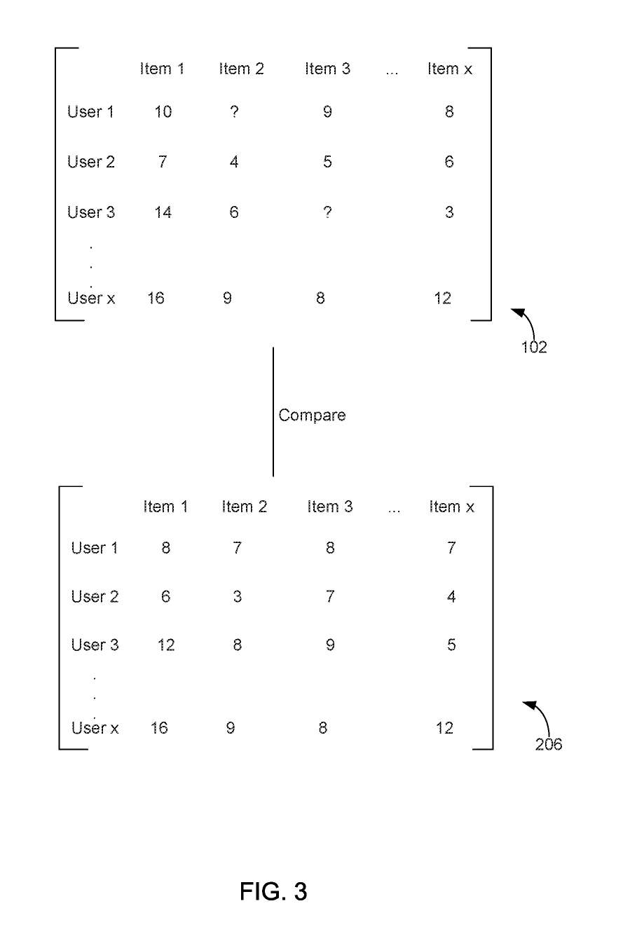

It should also be noted that other values, which exist in matrix 102, may be different in 206 from corresponding ones in 204. This is illustrated in FIG. 3. For example, in the original viewing matrix 102, it is indicated that user 1 viewed item 1 10 times, but that value is different, i.e., 8, in the estimated viewing matrix 206 based on the intermediate matrixes 202 and 204. Such differences may exist for other known values in the original viewing matrix 102 as shown in FIG. 3. Such differences are mainly due to imperfect factorization of matrix 102. A number of ways can be employed to improve the estimation. For example, a threshold may be predefined for a total difference between the original viewing matrix 102 and estimated viewing matrix 206. The threshold may represent an expected maximum Euclidean distance between the two matrixes. The two matrixes can then be compared. When the actual differences between the two are greater than the threshold, the factorization of the matrix 102 can be improved. For instance, the values of latent features can be recalculated for the factorization. Matrixes 202 and 204 can be reconstructed based on the new latent feature values. A new estimated matrix 206 can be obtained by multiplying reconstructed matrixes 202 and 204. The new estimated matrix 206 can then be compared to the original viewing matrix 102 to determine whether the differences between the two has overcome the threshold. If the difference between the two has not overcome the threshold, this iteration can continue—i.e., refactorizing and re-estimating the viewing matrix until the differences overcome the threshold. One skilled in the art will understand other iterative refactorizing and re-estimating the viewing matrix 206 to improve accuracy can be used under the collaborative approach.

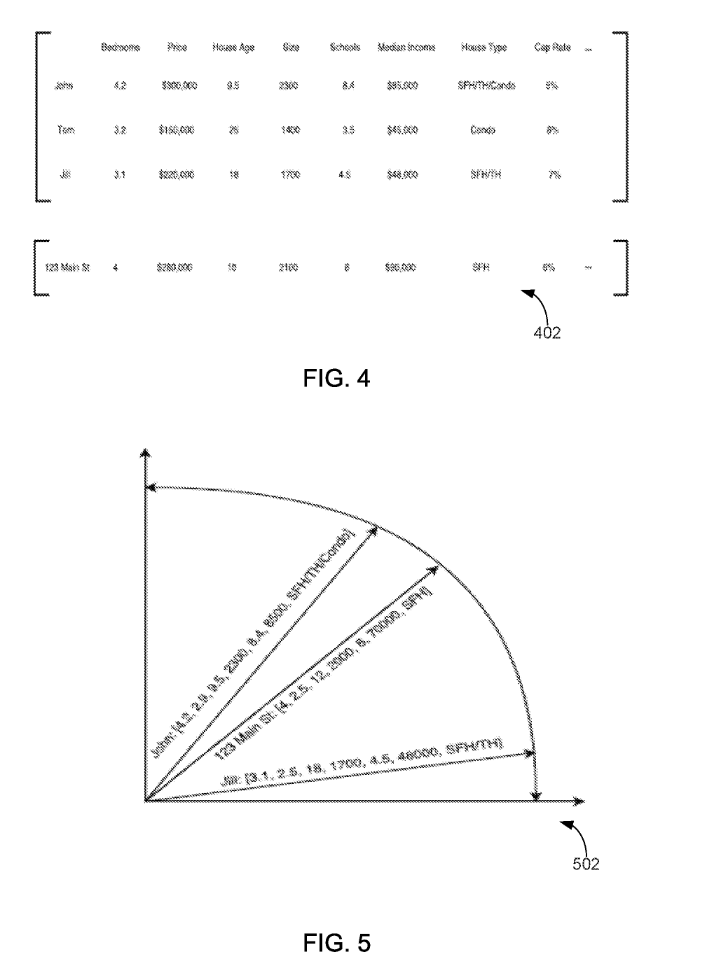

In some embodiments, a content filtering can be used to estimate a given user's interest toward an item to be recommended. Under the content filtering approach, a user profile with respect to a particular item can be constructed by analyzing user activities captured through the user activity data. A user vector can be built based on the user profile. The elements in a user vector for a given user can include various attributes derived from the user profile. FIG. 4 illustrates an example of user vectors 402 that can be built when the items include real-estate properties. The attributes for the user vector can include number of bedrooms, number of bathrooms, living area size, lot size, year built, cap rate, selling price, location: how close it is to user's location, schools ratings, property type (SFH, Condo, Townhouse), neighborhood demographics, income, median age, education level, poverty rate, unemployment rate and/or any other attributes. The value for each attribute for a given user may be calculated through averaging. For example, for user John, it is indicated in the vector that, for all of the real-estate properties that have been viewed by John, the average number of bedrooms is 4.2, average price is $300, 000, average house age is 9.5 year, average size is 2300 square feet, average rating of school where the house is nearby is 8.4, average median income where the house is located is 8.5, average house type is single family and condo, and average cap rate is 5% and etc. Similarly, a similar vector can be built for an item to be recommended. This is also illustrated in FIG. 4. As shown, a vector can be built for a house located in the 123 main street using the same attributes in the user vector.

For determining whether one or more particular items are to be recommended to a given user, the vector for the given user and the vector for the particular item(s) can be compared using cosine similarity as in vector space model. This can measure similarity between the item and derived user preference. The results can be ranked and the top results will be generated for the given user. FIG. 5 illustrates an example where vectors 402 shown in FIG. 4 can be plotted in a graph 502 and a determination of recommendation for an item can be made (e.g., 123 main street) to the users based on cosine similarities between the vector for that item and the user vectors.

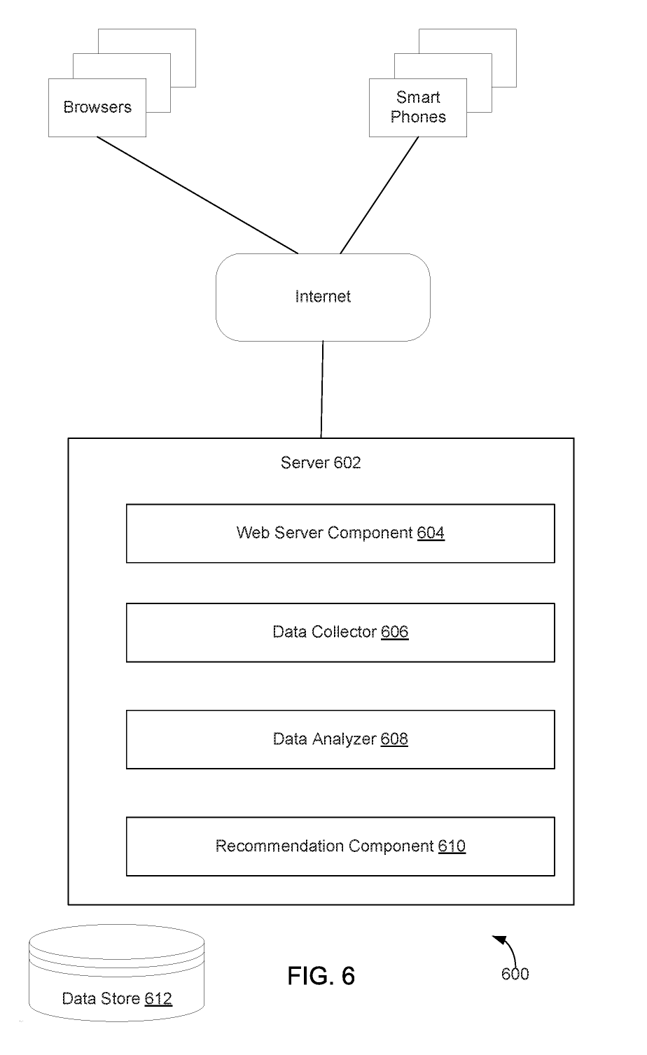

With various working principles of a user matching system having been generally described above, attention is now directed to FIG. 6 where an example of user matching system 600 in accordance with the disclosure is illustrated. As shown, the user matching system 600 can include a server 602. The server 602 can include one or more computer components including a web server component 604, a data collector 606, a data analyzer 608, a recommendation component 610, and/or any other components.

The web server component 604 can be configured to receive, via an internet, data requests from user applications such as browsers and apps as shown. The web server component 604 can be configured serve web pages to the user applications. In some embodiments, the web server component 604 can be configured to receive user data, such as user answers to questionnaire posted on one or more pages served by the web server component 604.

The data collector 606 can be configured to collect various user data as described and illustrated herein. The user data can be categorized for different purposes, and can be used in different models. In one embodiment, three categories are used: investment factors, personality factors and behavior factors as described and illustrated herein. In some exemplary implementations, the data collector 606 can be configured to obtain user data by presenting online questionnaires for user to provide answers. For example, the web server component 604 can be configured to present such questionnaires to the users via their browsers or apps. Once the users provide answers to the questionnaires and the web server component 604, the web server component 604 can be configured to forward the answer data to the data collector 606. The data collector 606 can be configured to extract relevant values from the user provided answers. However, this is not intended to be limiting. In some examples, the web server component 604 can be configured to receive browser cookies or app logs from the user applications and forward to the data collector 606. In those examples, the data collector 606 can be configured to parse the browser cookies or app logs to obtain various user data, for example the user activity data described and illustrated herein.

The data analyzer 608 can be configured to perform the collaborative filtering and/or content filtering as described and illustrated in FIGS. 11-15. The data analyzer 608 can be configured to apply data modeling using those filtering techniques to quantify user interests toward an item to be recommended.

The recommendation component 610 can be configured to determine whether to recommend an item to a given user based on the interest toward that item estimated by the data analyzer 608. For instance, the recommendation component 610 can be configured provide the given user a list of real-estate properties estimated to be of interest to the given user by the data analyzer as described and illustrated herein.

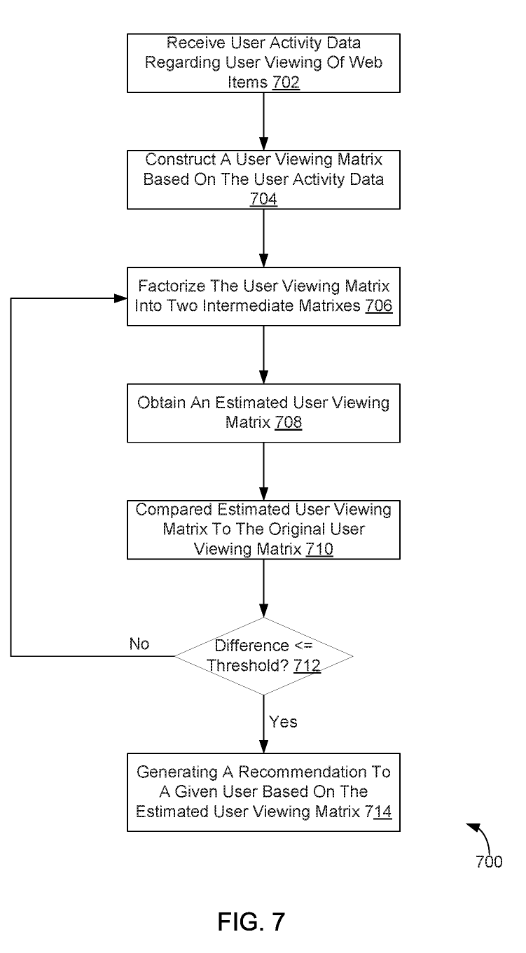

FIG. 7 illustrates an exemplary method for recommending one or more items to a given user in accordance with the disclosure. The method presented in FIG. 7 and described below is intended to be illustrative and non-limiting. The particular series of processing steps depicted in FIG. 7 is not intended to be limiting. It is appreciated that the processing steps may be performed in an order different from that depicted in FIG. 7 and that not all the steps depicted in FIG. 7 need be performed.

In some embodiments, the method depicted in method 700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 700 in response to instructions stored electronically on an electronic storage medium. The one or more processing devices may include one or more devices configured through hardware, firmware, and/or software to be specifically designed for execution of one or more of the operations of method 700.

At 702, user activity data regarding user viewing of web items can be received. As mentioned above, the user activity data received at 702 may include information indicating a number of times a given user has viewed a particular item. The item may include a web page, a product, a news story, an investment, a particular content. For example, the user activity data received at 702 may indicate that user 1 has viewed a particular real-estate property a certain number of times. In some exemplary implementations, operations involved in 702 may be implemented by a data collector the same as or substantially similar to the data collector 606 described and illustrated herein.

At 704, a user viewing matrix can be constructed based on the user activity data received at 702. An example of user viewing matrix that can be built at 704 is illustrated in FIG. 1. As described above, a value indicating certain user's viewing of a certain item may be missing in the viewing matrix constructed at 704. In some exemplary implementations, operations involved in 704 may be implemented by a data analyzer the same as or substantially similar to the data analyzer 608 described and illustrated herein.

At 706, the user viewing matrix constructed at 704 can be factorized into multiple intermediate matrixes using a collaborative filtering technique. An example of the factorizing that can be performed at 706 is illustrated in FIG. 2. In some exemplary implementations, operations involved in 706 may be implemented by a data analyzer the same as or substantially similar to the data analyzer 608 described and illustrated herein.

At 708, an estimated user viewing matrix can be obtained based on the intermediate matrixes factorized at 706. An example of the estimation that can be performed at 708 is illustrated in FIG. 2. As described above, the user viewing matrix estimated at 708 may contain values missing in the original user viewing matrix constructed at 704, and/or may contain values that are different from corresponding ones in the original user viewing matrix constructed at 704. In some exemplary implementations, operations involved in 708 may be implemented by a data analyzer the same as or substantially similar to the data analyzer 608 described and illustrated herein.

At 710, the user viewing matrix estimated at 708 and the original user viewing matrix constructed at 704 can be compared. The comparison at 710 can involve determining a Euclidean distance between the two matrixes. In some exemplary implementations, operations involved in 708 may be implemented by a data analyzer the same as or substantially similar to the data analyzer 608 described and illustrated herein.

At 712, the difference between the two matrixes as determined at 710 can be compared with a predetermined threshold. As shown, when the difference is greater than the threshold, method 700 can proceed back to 706 to perform 706, 708, and 710 again by re-factorizing and re-estimating the user viewing matrix as described and illustrated herein. When the difference is less than or equal to the threshold, the method can proceed to 714. In some exemplary implementations, operations involved in 714 may be implemented by a data analyzer the same as or substantially similar to the data analyzer 608 described and illustrated herein.

At 714, a recommendation of one or more items may be made to a given user based on the user viewing matrix estimated at 712. For example, the one or more items may include an item that has not been viewed by the given user as indicated by the user activity data, and is estimated to be viewed by the given user above a threshold number of times if presented to the given user based on the corresponding value in the user viewing matrix estimated at 712. In some exemplary implementations, operations involved in 714 may be implemented by a recommendation component the same as or substantially similar to the recommendation component 610 described and illustrated herein.

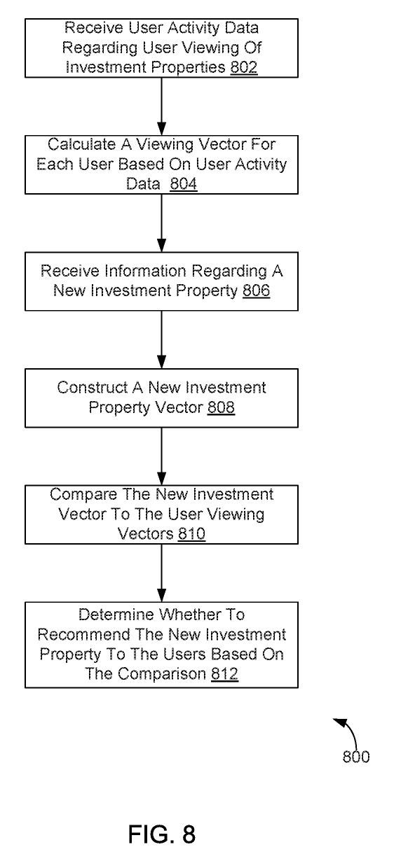

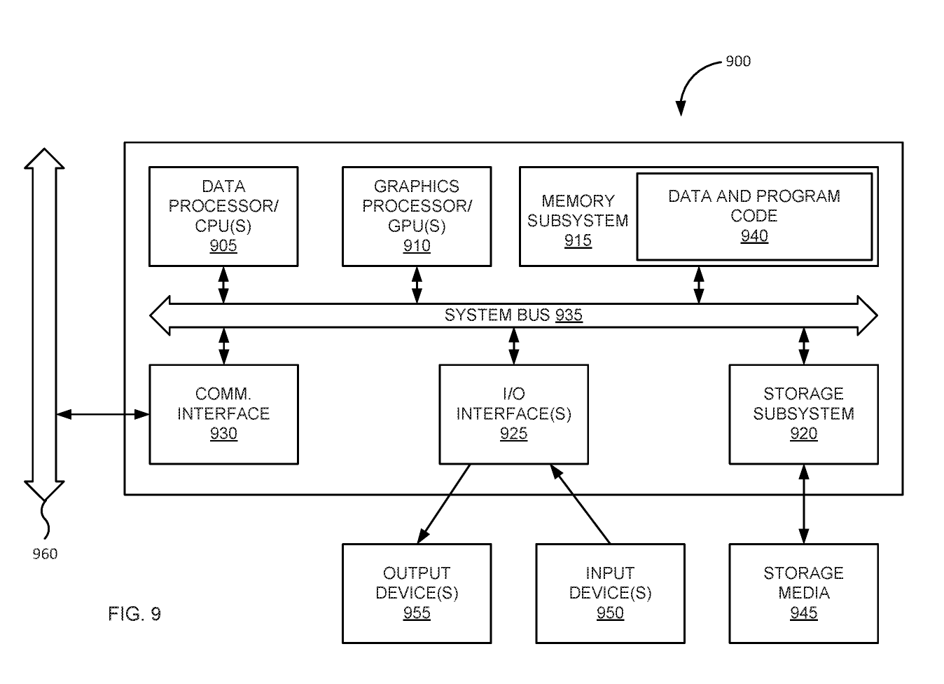

FIG. 8 illustrates an exemplary method for recommending one or more investment to a given user in accordance with the disclosure. The method presented in FIG. 8 and described below is intended to be illustrative and non-limiting. The particular series of processing steps depicted in FIG. 8 is not intended to be limiting. It is appreciated that the processing steps may be performed in an order different from that depicted in FIG. 8 and that not all the steps depicted in FIG. 8 need be performed.

In some embodiments, the method depicted in method 800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800.

At 802, user activity data regarding user viewing of investment properties can be received. As mentioned above, the user activity data received at 802 may include information indicating a number of times a given user has viewed a particular investment property. The investment property may include a real-estate property, a stock, a commodity, and/or any other investment properties. For example, the user activity data received at 802 may indicate that user 1 has viewed a particular real-estate property a certain number of times. In some exemplary implementations, operations involved in 802 may be implemented by a data collector the same as or substantially similar to the data collector 606 described and illustrated herein.

At 804, a user vector can be constructed for each user based on the user activity data received at 802. An example of user vector that can be built at 804 is illustrated in FIG. 4. As described above, the elements in the user vector may be calculated by averaging a particular feature viewed by a given user across all real-estate properties. For example, if the user has viewed 4 properties having 3, 3, 5 and 3 bedrooms, then the element of the number of bedroom viewed by the user in the vector can be 3.5. In some exemplary implementations, operations involved in 804 may be implemented by a data analyzer the same as or substantially similar to the data analyzer 608 described and illustrated herein.

At 806, information regarding a new investment can be received. The information received at 806 may include bedroom, number of bathrooms, living area size, lot size, year built, cap rate, selling price, location: how close it is to user's location, schools ratings, property type (SFH, Condo, Townhouse), neighborhood demographics, income, median age, education level, poverty rate, unemployment rate and/or any other information regarding a new real-estate property. In some exemplary implementations, operations involved in 806 may be implemented by a data collector the same as or substantially similar to the data collector 606 described and illustrated herein.

At 808, a new investment vector can be constructed based on the information received at 806. The new investment vector can have the same elements as the user vectors constructed at 804. An example of the new investment vector that can be constructed at 808 is illustrated in FIG. 4. In some exemplary implementations, operations involved in 808 may be implemented by a data analyzer the same as or substantially similar to the data analyzer 608 described and illustrated herein.

At 810, the new investment vector constructed at 808 and the user vectors constructed at 804 can be compared. The comparison at 810 can involve determining a cosine similarity between the new investment vector and each of the user vectors. In some exemplary implementations, operations involved in 810 may be implemented by a data analyzer the same as or substantially similar to the data analyzer 608 described and illustrated herein.

At 812, a determination may be made whether the new investment is to be recommended to the users based on the comparison at 810. For example, a threshold cosine similarity can be used at 812 such that the new investment will be recommended to any user having a user vector having cosine similarity with respect to the new investment vector less than or equal to the threshold cosine similarity. In some exemplary implementations, operations involved in 812 may be implemented by a recommendation component the same as or substantially similar to the recommendation component 610 described and illustrated herein.

FIG. 9 is a block diagram of computer system 900 that can be used to implement various embodiments described and illustrated herein. FIG. 9 is merely illustrative. In some embodiments, a computer system includes a single computer apparatus, where the subsystems can be the components of the computer apparatus. In other embodiments, a computer system can include multiple computer apparatuses, each being a subsystem, with internal components. Computer system 900 and any of its components or subsystems can include hardware and/or software elements configured for performing methods described herein.

Computer system 900 may include familiar computer components, such as one or more one or more data processors or central processing units (CPUs) 905, one or more graphics processors or graphical processing units (GPUs) 910, memory subsystem 915, storage subsystem 920, one or more input/output (I/O) interfaces 925, communications interface 930, or the like. Computer system 900 can include system bus 935 interconnecting the above components and providing functionality, such connectivity and inter-device communication.

The one or more data processors or central processing units (CPUs) 905 can execute logic or program code or for providing application-specific functionality. Some examples of CPU(s) 905 can include one or more microprocessors (e.g., single core and multi-core) or micro-controllers, one or more field-gate programmable arrays (FPGAs), and application-specific integrated circuits (ASICs). As used herein, a processor includes a multi-core processor on a same integrated chip, or multiple processing units on a single circuit board or networked.

The one or more graphics processor or graphical processing units (GPUs) 910 can execute logic or program code associated with graphics or for providing graphics-specific functionality. GPUs 910 may include any conventional graphics processing unit, such as those provided by conventional video cards. In various embodiments, GPUs 910 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 910 may include any number of registers, logic units, arithmetic units, caches, memory interfaces, or the like.

Memory subsystem 915 can store information, e.g., using machine-readable articles, information storage devices, or computer-readable storage media. Some examples can include random access memories (RAM), read-only-memories (ROMS), volatile memories, non-volatile memories, and other semiconductor memories. Memory subsystem 915 can include data and program code 940.

Storage subsystem 920 can also store information using machine-readable articles, information storage devices, or computer-readable storage media. Storage subsystem 920 may store information using storage media 945. Some examples of storage media 945 used by storage subsystem 920 can include floppy disks, hard disks, optical storage media such as CD-ROMS, DVDs and bar codes, removable storage devices, networked storage devices, or the like. In some embodiments, all or part of data and program code 940 may be stored using storage subsystem 920.

The one or more input/output (I/O) interfaces 925 can perform I/O operations. One or more input devices 950 and/or one or more output devices 955 may be communicatively coupled to the one or more I/O interfaces 925. The one or more input devices 950 can receive information from one or more sources for computer system 900. Some examples of the one or more input devices 950 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 950 may allow a user of computer system 900 to interact with one or more non-graphical or graphical user interfaces to enter a comment, select objects, icons, text, user interface widgets, or other user interface elements that appear on a monitor/display device via a command, a click of a button, or the like.

The one or more output devices 955 can output information to one or more destinations for computer system 900. Some examples of the one or more output devices 955 can include a printer, a fax, a feedback device for a mouse or joystick, external storage systems, a monitor or other display device, a communications interface appropriately configured as a transceiver, or the like. The one or more output devices 955 may allow a user of computer system 900 to view objects, icons, text, user interface widgets, or other user interface elements. A display device or monitor may be used with computer system 900 and can include hardware and/or software elements configured for displaying information.

Communications interface 930 can perform communications operations, including sending and receiving data. Some examples of communications interface 930 may include a network communications interface (e.g. Ethernet, Wi-Fi, etc.). For example, communications interface 930 may be coupled to communications network/external bus 960, such as a computer network, a USB hub, or the like. A computer system can include a plurality of the same components or subsystems, e.g., connected together by communications interface 930 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

Computer system 900 may also include one or more applications (e.g., software components or functions) to be executed by a processor to execute, perform, or otherwise implement techniques disclosed herein. These applications may be embodied as data and program code 940. Additionally, computer programs, executable computer code, human-readable source code, shader code, rendering engines, or the like, and data, such as image files, models including geometrical descriptions of objects, ordered geometric descriptions of objects, procedural descriptions of models, scene descriptor files, or the like, may be stored in memory subsystem 915 and/or storage subsystem 920.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A method for generating a recommendation to a user, the method being implemented by a processor configured to execute computer programs, the method comprising:
receiving user activity data indicating viewing of a set of web items by users;
constructing a user vector based on user activity data for a given user;
receiving item information regarding a given web item;
constructing an item vector based on the item information regarding the given web item;
comparing the user vector with the item vector;
determine a difference between the user vector and item vector is less than a predetermined threshold value based on the comparison; and
generating a recommendation including information indicating the given web item to the given user by virtue of the difference between the user vector and item vector being less than the predetermined threshold value.

2. The method of claim 1, wherein the web items include a webpage listing information regarding at least one of a real-estate property, an investment item including a stock, a bond, and a mutual fund, a news story, and a product.

3. The method of claim 1, wherein constructing the user vector comprises calculating a number of times the given user has viewed a set of features related to the web items.

4. The method of claim 3, wherein calculating the number of times the given user has viewed a first feature related to the web items comprises: obtaining an average number of times the given user has viewed the first feature across the web items.

5. The method of claim 1, wherein the item vector indicates a set of features related to the given web item.

6. The method of claim 1, wherein comparing the user vector with the item vector comprises: determining a cosine similarity value between the user vector and the item vector.

7. The method of claim 1, further comprising:
constructing a second user vector based on user activity data for a second user, wherein the user vector constructed for the given user is a first user vector and the given user is the first user;
comparing the second user vector with the item vector;
determine a difference between the second user vector and item vector is greater than the predetermined threshold value based on the comparison; and
in response to the determination that the difference between the user vector and item vector being greater than the predetermined threshold value, determine not to generate a recommendation of the given web item to the second user.

8. The method of claim 1, further comprises determining the given web item has not been viewed by the given user based on the user activity data.

9. A method for generating a recommendation to a user, the method being implemented by a processor configured to execute computer programs, the method comprising:
receiving user activity data indicating viewing of web items by users;
constructing an original user viewing matrix based on user activity data for a given user;
factorizing the original user viewing matrix into a first matrix and a second matrix using a set of latent features;
obtaining an estimated user viewing matrix using the first and second matrixes;
comparing a difference between the estimated user viewing matrix and the original matrix with a predetermined threshold;
in response to the difference between the estimated user viewing matrix and the original matrix being greater than the predetermined threshold, repeating factorizing the original user viewing matrix, obtaining the estimated user viewing matrix, and comparing the difference between the estimated user viewing matrix and the original matrix with a predetermined threshold until the difference between the estimated user viewing matrix and the original matrix is less than or equal to the predetermined threshold; and
generating a recommendation to the given user based on the estimated user viewing matrix.

10. The method of claim 9, wherein the web items include at least one of a webpage listing information regarding a real-estate property, an investment item including a stock, a bond, and a mutual fund, a news story, and a product.

11. The method of claim 9, wherein constructing the original user viewing matrix comprises calculating a number of times the given user has viewed each of the web items.

12. The method of claim 9, wherein factorizing the original user viewing matrix into the first matrix and a second matrix using a set of latent features comprises: determining values for the set of latent features based on the user activity data.

13. The method of claim 9, wherein obtaining the estimated user viewing matrix using the first and second matrixes comprises multiplying the first and second matrixes to obtain the estimated user viewing matrix.

14. The method of claim 9, further comprising: determining the difference between the estimated user viewing matrix and the original matrix by computing a Euclidean distance between the estimated user viewing matrix and the original matrix.

15. The method of claim 9, wherein repeating factorizing the original user viewing matrix comprises re-determining values for the set of latent features.

16. The method of claim 9, wherein the recommendation includes a web item not viewed by the given user as indicated by the user activity data.
